(19) United States
(12) Patent Application Publication
(10) Pub. No.: US 2026/0265033 A1
(43) Pub. Date: Sep. 10, 2026

(54) ARTIFICIAL INTELLIGENCE SUPPORTED FORKLIFT PEDAL STRUCTURE

(71) Applicant: ONSEK BUNKE IS MAKINELERI OTOMOTIV SANAYI TICARET ANONIM SIRKETI, Nilüfer, Bursa (TR)

(72) Inventor: Ayaz ARAS, Nilüfer, Bursa (TR)

(21) Appl. No.: 19/165,929

(22) PCT Filed: Dec. 18, 2024
(86) PCT No.: PCT/TR2024/051621

§ 371 Date: Sep. 16, 2025

(30) Foreign Application Priority Data
Jun. 5, 2024 (TR) 2024/007149

(51) Int. Cl. B66F 9/075

(52) U.S. Cl. CPC B66F 9/07572

(57) ABSTRACT

The invention relates to an artificial intelligence (AI) supported forklift pedal structure ((pedal-1 (1), pedal-2 (2)) that offers forward and backward movement with a single pedal ((pedal-1 (1) and pedal-2 (2)) or forward and backward movement with two pedals ((pedal-1 (1) and pedal-2 (2)) in the walking systems to the forklifts.

### TECHNICAL FIELD

The invention relates to the artificial intelligence (AI) supported forklift pedal structure, which allows forklifts to move forward and backward with a single pedal or forward and backward with two pedals in their walking systems.

### PRIOR ART

Forklift is a type of work machine used to lift heavy loads using its forks and especially to load them onto a vehicle or rack. Forklifts are mostly used to carry, lift and stack loaded weights on pallets.

There are small models of forklifts that can be moved by hand, as well as large and motorized models. They can have capacities from 1 ton to 90 tons. There are diesel engine, gasoline engine and LPG engine types for use in open areas, and battery-powered electric motors that can operate with AC and DC current for use in closed areas.

As with every machine, there are improvements for forklifts to address various disadvantages. There are a few examples in this direction below.
2024/004441 13.04.2024 real-time location-based forklift action taking method
2024/000600 18.01.2024 forklift steering transmission system
2024/000598 18.01.2024 forklift gas system
2023/014217 01.11.2023 innovation in forklift attachment
2023/004059 12.04.2023 improved forklift structure

Considering the examples above and the literature and industrial environment, the possibility of using forklifts with the alternative of using double or single pedals has not been provided so far. However, this lack of usage alternatives can create a significant need, especially during operator changes.

In addition, this lack of usage alternatives can lead to some time-consuming and costly problems, such as the forklift not being able to be used if there is a problem in using one of the pedals.

In addition, there is no possibility in the present art for an operator who is accustomed to single-pedal use to find both alternatives in a single forklift structure to switch to double-pedal use.

In addition, it is not possible to talk about an artificial intelligence (Al) supported forklift structure in current technologies. In this context, the formation of artificial intelligence integrated with the pedal structure and walking system is an inevitable development gap today.

### DEFINITION OF THE INVENTION

The invention eliminates the disadvantages described in the prior art and meets the needs.

The invention relates to the artificial intelligence-supported forklift pedal structure, which allows forklifts to move forward and backward with a single pedal or forward and backward with two pedals in their walking systems.

In the invention, a multifunctional use can be offered with the advantage of double or single pedal use.

In the invention, any trigger element on the forklift can be used for double or single pedal use. For example, the electronic card that detects sound with the help of a voice command can activate the use of single pedal or double pedal by receiving the command by means of the sound sensor (7) to which it is fed.

In the invention, when switching to single pedal, it is possible to move forward and backward by means of the direction arm (direction device) on the forklift, an in this case, the transition to single pedal use and use can be made very easily. In said invention, safe driving can be increased with the use of two pedals, and the brake pedal is used less, allowing forward movement to be made with one pedal and reverse movement with the other pedal, without using arm strength.

The invention can offer the advantage of being able to use the same vehicle to all operators, with the possibility of using both single pedal and double pedal.

The invention also provides an embodiment for determining which pedal will move backwards and which pedal will move forward in double pedal use by means of the magnetic sensor located on the pedal. In this way, it provides the opportunity to determine the desired pedal forward or reverse pedal usage advantage in double pedals during production, depending on the placement of the magnetic sensor.

In the invention, the effect of acceleration can be regulated by how much the pedal is pressed by means of the Hall effect sensor.

By means of the infrared sensor in said invention, it provides safe driving by providing reverse movement with the data coming from the light sensor, even if the vehicle is in a dark environment, especially when using one pedal, even when the vehicle direction indicator is in the forward direction.

### LIST OF REFERENCES

1. Pedal-1
2. Pedal-2
4. Direction element
5. Option trigger element
6. Electric element on forklift
7. Sound sensor
8. Magnetic sensor
9. Hall effect sensor
10. Infrared sensor
11. Ultrasonic sensor

### BRIEF DESCRIPTION OF FIGURES

FIG. 1 is a representative view of the connections of the system.

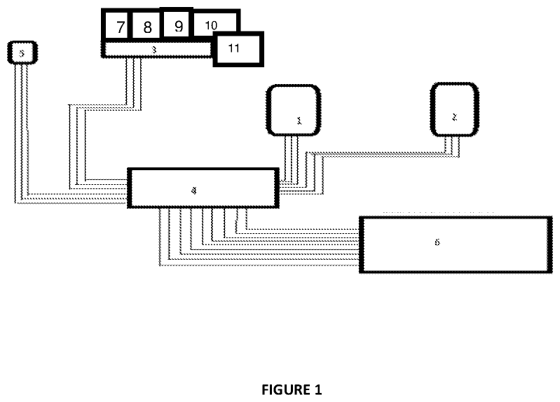

### DESCRIPTION OF THE INVENTION

The invention is an artificial intelligence (AI) supported forklift pedal structure, wherein; it has a single or double pedal ((pedal-1 (1) or pedal-2 (2)) controlled usage structure.

The invention is a multifunctional embodiment for a forklift and is described with the following elements in a non-limiting manner:

Pedal-1 (1); It is the part of the forklift that adjusts its speed and moves forward or backward.

Pedal-2 (2); It is the part of the forklift that adjusts its speed and moves forward or backward.

One of the elements pedal-1 (1) or pedal-2 (2) is disabled in the single pedal operation option, and the activated pedal (either of pedal-1 (1) or pedal-2 (2)) can provide forward and backward movement by means of to the direction element (4).

Electronic card (3) is a structure that works depending on the electrical element (6) on the forklift, and has a circuit that will serve the purpose of using double pedals and deactivating one of the pedals (pedal-1 (1) and pedal-2 (2)) on the circuit with the command received from the option trigger element (5) and transfers the command coming from the direction element (4) to the pedal in the circuit, with the task of ensuring that pedal-1 (1) and pedal-2 (2) are activated at the same time with the command received from the optional trigger element (5).

Direction element (4) is the device that determines in which direction (forward-backward) the pedal ((pedal-1 (1) or pedal-2 (2)) will move, via the electronic card (3) when using a single pedal ((pedal-1 (1) or pedal-2 (2)). This can be a control stick, a button, a device comprising a sound sensor (7) that detects a voice command, or any object with a directional indicator.

The option trigger element (5) is the element used to select single or double pedal ((pedal-1 (1) or pedal-2 (2)) and works connected to the electronic card (3). This can be a control stick, a button, a device comprising a sound sensor (7) that detects a voice command, or any device with an option indicator.

The electrical element (6) on the forklift is the device to which the electronic card (3) is connected (for example, the potentiometer on a mechanical forklift or the battery circuit board on an electric forklift, etc.).

Said invention can be used and applied in both electrical and mechanical forklifts.

In the invention, there is also an embodiment for determining which pedal (pedal-1 (1) and/or pedal-2 (2)) will move backward and which pedal (pedal-1 (1) and/or pedal-2 (2)) will move forward in double pedal use, with the magnetic sensor (8) (metal sensor) on the pedal (pedal-1 (1) and/or pedal-2 (2)).

In the invention, there may be a Hall effect sensor (9) on pedal-1 (1) and/or pedal-2 (2). By means of this hall effect sensor (9), the movement speed of the forklift can be determined according to the pressure applied to the pedal (pedal-1 (1) and/or pedal-2 (2)).

With the infrared sensor (10) to be used in said invention, if the forklift is moving towards a dark environment, it will detect this, and with the data sent to the electronic card (3), it is provided that the direction element (4) will act in the opposite direction, enabling the vehicle to go in the opposite direction or be disabled instead of going towards the darkness.

In said invention, when an obstacle is encountered through the ultrasonic sensor (11), it can be detected and the data sent to the electronic card (3) will enable the direction element (4) to act in the opposite direction, enabling the vehicle to go in the opposite direction to be disabled instead of going towards the darkness.

Representative working principle of said invention;

When the operator starts the forklift, he/she chooses to use single or double pedal ((pedal-1 (1) or pedal-2 (2)) by means of the option trigger element (5). With the instruction coming from the option trigger element (5), the electronic card (3) activates both pedal-1 (1) and pedal-2 (2) pairs if the dual-use option is chosen. In this way, when the operator presses pedal-1 (1), for example, the forklift moves forward, while, when the operator presses pedal-2 (2), the forklift moves backwards. If the operator selects the single option by means of the option trigger element (5), the electronic circuit board (3) activates a single pedal (((pedal-1 (1) or pedal-2 (2)) with the instruction coming from the option trigger element (5) and by means of the direction element (4), the operator determines which direction to go when the active pedal is pressed. The electronic card (3) is equipped before use (during production) according to the instructions coming through the optional trigger element (5).

1. An artificial intelligence (AI) supported forklift pedal structure having an electrical element on the forklift to which an electronic card is connected, comprising a single or double pedal controlled usage structure comprising:
a first pedal that adjusts a speed of the forklift and moves the forklift forward or backward;
a second pedal that adjusts the speed of the forklift and moves the forklift forward or backward;
wherein the electronic card works depending on the electrical element on the forklift, and has a circuit that serves the purpose of using double pedals and deactivating one of the pedals on the circuit with a command received from an optional trigger element and transfers the command coming from the direction element to the pedal in the circuit, with the task of ensuring that first pedal and second pedal are activated at the same time with the command received from the optional trigger element;
a direction element that determines which direction (forward-backward) the first pedal second or pedal will move via the electronic card in the use of a single pedal; and
wherein the optional trigger element is connected to the electronic card to select single or double pedal usage.

2. The artificial intelligence (AI) supported forklift pedal structure of claim 1, wherein the optional trigger element has a second sound sensor and can receive voice commands.

3. The artificial intelligence (AI) supported forklift pedal structure of claim 1, comprising a third button on the optional trigger element.

4. The artificial intelligence (AI) supported forklift pedal structure of claim 1, wherein the optional trigger element has a control stick.

5. The artificial intelligence (AI) supported forklift pedal structure of claim 1, wherein direction element has a sound sensor and can receive voice commands.

6. The artificial intelligence (AI) supported forklift pedal structure of claim 1, wherein the directional element is a button.

7. The artificial intelligence (AI) supported forklift pedal structure of claim 1, wherein the directional element is a control stick.

8. The artificial intelligence (AI) supported forklift pedal structure of claim 1, comprising a magnetic sensor located on one or more of the first pedal and second pedal to determine which pedal or pedals will move backward and which pedal or pedals will move forward in double pedal use.

9. The artificial intelligence (AI) supported forklift pedal structure of claim 1, comprising a hall effect sensor on one or more of the first pedal through which the movement speed of the forklift can be determined according to the pressure applied to one or more of the first pedal and second pedal.

10. The artificial intelligence (AI) supported forklift pedal structure of claim 1, comprising an infrared sensor that is responsible for ensuring that the direction element acts in the opposite direction or is disabled by detecting and sending this data to the electronic card if the forklift is moving towards a dark environment.

11. The artificial intelligence (AI) supported forklift pedal structure of claim 1, comprising an ultrasonic sensor that is responsible for ensuring that the direction element acts in the opposite direction or is disabled by detecting and sending this data to the electronic card if the forklift is moving towards an obstacle.
